(19) United States
(12) Patent Application Publication
(10) Pub. No.: US 2011/0164590 A1
(43) Pub. Date: Jul. 7, 2011

(54) METHOD FOR UE HANDOVER BETWEEN HOME NODE BS

(75) Inventors: Hong Wang, Beijing (CN); Huarui Liang, Beijing (CN); Ke Geng, Beijing (CN); Lixiang Xu, Beijing (CN)

(73) Assignee: SAMSUNG ELECTRONICS CO., LTD., Suwon-city, Gyeonggi-do (KR)

(21) Appl. No.: 12/997,115

(22) PCT Filed: Jun. 9, 2009
(86) PCT No.: PCT/KR09/03085

§ 371 Date: Dec. 9, 2010

(30) Foreign Application Priority Data
Jun. 13, 2008 (CN) 200810125575.0

(51) Int. Cl. H04W 36/00

(52) U.S. Cl. 370/331

(57) ABSTRACT

The present invention provides a method for User Equipment (UE) handover between home Node Bs, comprising steps of: sending, by a source home Node B that stores the ID of the connected gateway, a message to the gateway, the message including the gateway ID and a destination home Node B ID; sending by the gateway a message to the destination home Node B identified by the destination home Node B ID to establish a radio bear of the destination home Node B for the UE; sending by the destination home Node B the radio bearer allocated to the UE to the gateway; sending by the gateway the radio bearer to the source home Node B; sending by the source home Node B the radio bearer to the UE; and completing by the UE a handover to the destination home Node B. With the present invention, successful handover between home Node Bs under the same access control can be guaranteed in the case of the same gateway. Meanwhile, it is not necessary to make any modification to the current 3GPP protocol signaling, and the present invention is compliant with the protocol signaling for interfaces Uu and Iu.

### TECHNICAL FIELD

The present invention relates to mobile communication, and in particular to a method for User Equipment (UE) handover between home Node Bs.

### BACKGROUND ART

In a current 3G mobile communication system, a new type of home Node B is drawing an increasing amount of attention. This indoor home Node B is provided within a house and can meet home requirement. It has advantages of exclusively occupying a radio mobile network, so that a superior network quality can be guaranteed. A network structure of the home Node B is illustrated in FIG. 4, in which home Node B 1 is just the same type.

Meanwhile, several home Node Bs can form a home Node B group under the control of one same gateway, and they have the same access control or no access control. In this way, a group of users can access freely, so that their network requirements can be met. This solution can be applied in such sites as office buildings, coffee bars, factories, schools, middle-scaled and small-scaled enterprises and on the like to guarantee the network quality for the users in these sites. The network structure of this home Node B group is illustrated in FIG. 4, in which home Node B 2, home Node B 3 and home Node B 4 belong to the same group and have the same access control.

In the above home Node B group comprising a plurality of home Node Bs, a mobile phone often moves from one home Node B to another, leading to frequent occurrences of handover between home Node Bs. The present invention is intended to provide a solution for handover between home Node Bs of the above type.

For handover between home Node Bs within one same group, no specific discussion or conclusion is given in any of the existing standards.

Since the home Node B has incorporated the function of radio network controller, the handover between this type of home Node Bs is analogous to that between conventional radio network controllers. Unfortunately, no interface similar to that between conventional radio network controllers exists among such home Node Bs.

Thus, the handover has to be implemented through relocation. With the conventional techniques, participation of a core network is required for the realization of relocation signaling. If no new function is added to the gateway, the relocation can not be achieved, as illustrated in FIG. 5.

FIG. 5 illustrates a conventional solution. In Step 7, a “relocation failure” message appears and leads to the failure of handover. The fundamental reason for this failure is that the gateway has no capability of processing relocation signaling. Specifically, it can only forward messages, and cannot realize addressing to a new home Node B.

According to the old solution, a source radio network controller ID in a “relocation request message” has the same value as a destination radio network controller ID. And it is not compliant with the standard process flow to transmit the “relocation request message” to a core network.

During the entire relocation process, the gateway implements no substantial processing but only message forwarding. If the processing function of the gateway can be made full use to determine that the mobile phone is under the control of the gateway itself at the time of initiation of the relocation, the gateway can implement the entire relocation and handover process without participation of the core network.

In the existing system, a Node B, upon initialization, can obtain a unique cell ID under a radio network controller to identify different cells under the coverage of the Node B. It is not necessary for the Node B to learn about the radio network controller's ID. For a radio network controller, its ID is configured through operation and maintenance. It is not necessary for the radio network controller to learn about the ID of any higher-level node.

### DISCLOSURE OF INVENTION

### Technical Solution

The object of the present invention is to provide a method for User Equipment (UE) handover between home Node Bs.

To achieve the above object, a method for User Equipment (UE) handover between home Node Bs is provided comprising steps of:
sending, by a source home Node B that stores an ID of a connected gateway, a message to the gateway, the message including a gateway ID and a destination home Node B ID;
sending by the gateway a message to a destination home Node B identified by the destination home Node B ID to establish a radio bear of the destination home Node B for the UE;
sending by the destination home Node B a radio bearer allocated to the UE to the gateway;
sending by the gateway the radio bearer to the source home Node B;
sending by the source home Node B the radio bearer to the UE; and
completing by the UE a handover to the destination home Node B.

With the present invention, successful handover between the home Node Bs under the same access control can be guaranteed in the case of the same gateway. Meanwhile, it is not necessary to make any modification to the current 3GPP protocol signaling, and the present invention is compliant with the protocol signaling for interfaces Uu and Iu.

### BRIEF DESCRIPTION OF DRAWINGS

FIG. 1 is a flowchart of improved handover between home Node Bs under one same gateway;

FIG. 2 shows an embodiment of initialization flow of a home Node B;

FIG. 3 is a schematic diagram of a global cell ID of the home Node B;

FIG. 4 shows the network structure of the home Node B;

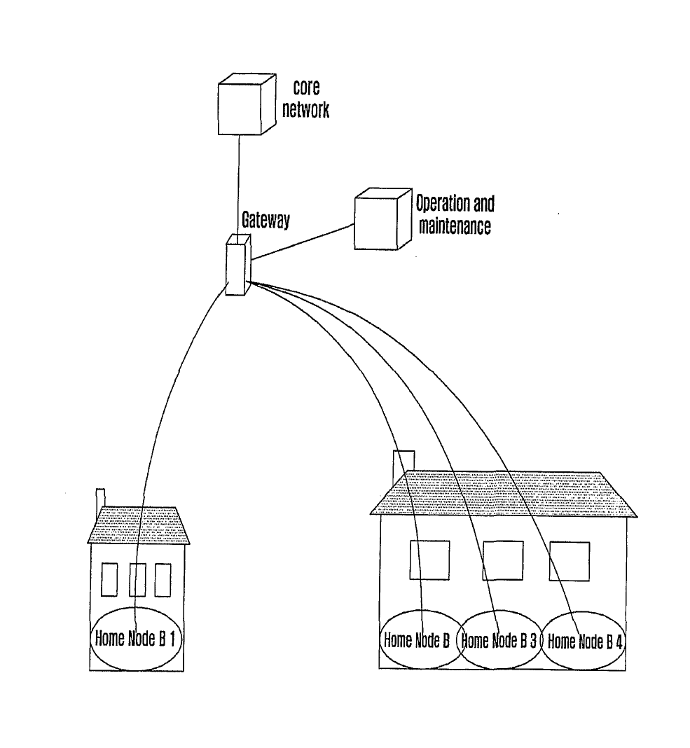

FIG. 5 shows a flowchart of conventional handover between home Node Bs under one same gateway;

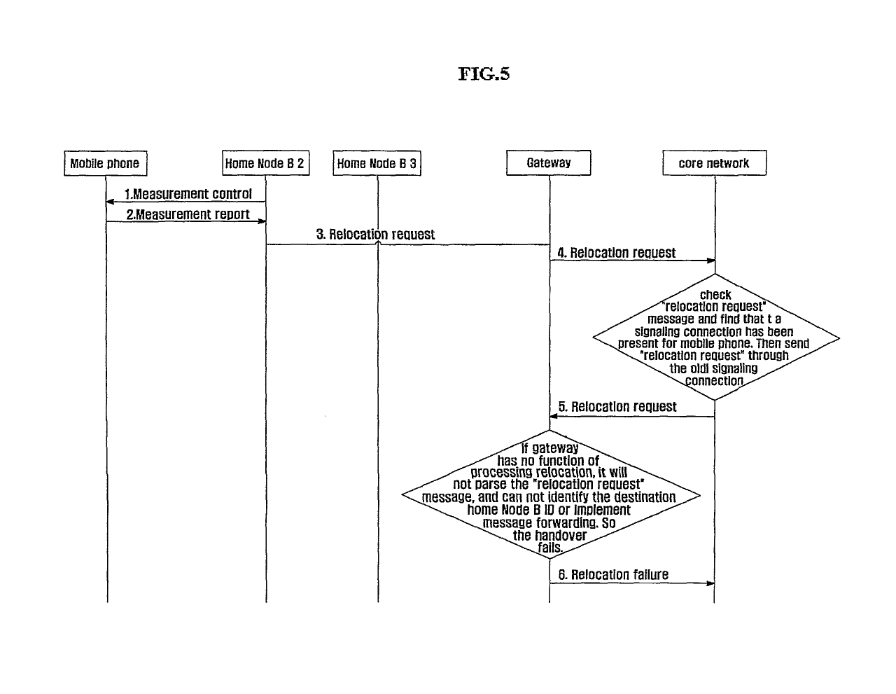

FIG. 6 is a schematic diagram of a conventional global cell ID.

### MODE FOR THE INVENTION

When a home Node B triggers a relocation process, a gateway determines that the destination cell is under the same access control or no access control, and the destination cell is under the control of this gateway. Then, the gateway can act as a core network to implement the relocation process. Otherwise, the relocation process is handled by the core network.

To support the above function, it is necessary to allocate a gateway ID to each home Node B. With the allocated ID, the home Node B can obtain a radio network controller ID. And according to a relocation message inserted with the radio network controller ID, the gateway can determine whether the relocation process is under its control. Moreover, a unique home Node B ID is allocated to each home Node B under the same gateway. With this ID, the gateway can find the destination home Node B.

The above solution is directed to handover under the same access control group and the same gateway.

The present invention provides a method for supporting handover between home Node Bs. The method includes the following steps.

1) Each home Node B obtains its home Node B ID, gateway ID and information on its adjacent cells from the network. The information on adjacent cells includes information on any other home Node B available for handover.

2) The source home Node B decides to hand a UE over to a destination home Node B and thus sends a “relocation request” message to the gateway.

3) The gateway parses the “relocation request” message and determines, according to an information element “destination cell ID”, whether the implementation of a relocation process needs the participation of a core network or not. If not, the gateway locates the destination home Node B according to the information element “destination cell ID”.

4) The gateway processes the relocation message and implements the relocation process.

The above Step 1) can further comprise the following sub-steps.

1) The home Node B reports its information to an operation and maintenance entity at the time of initial power-on. The reported information includes location information of the home Node B, and possibly information on adjacent cells searched by the home Node B. Such information includes public mobile network ID, global cell ID, frequencies, scrambling, route cell ID and so on. If the home Node B covers more than one cell, the information also includes local cell ID.

2) The operation and maintenance entity configures the home Node B with Node B ID, gateway ID, public mobile network ID, frequencies, scrambling, route cell ID and so on. In addition, the operation and maintenance entity obtains information on other home Node Bs within the same control group. The information includes public mobile network IDs, global cell IDs, frequencies, scrambling, route cell IDs and the like used by other home Node Bs. If the home Node B covers more than one cell, the information also includes local cell ID. Meanwhile, an ID is allocated to each cell under the home Node B to uniquely identify a cell under the gateway.

The above Step 1) can further comprise the following sub-steps.

1) The home Node B reports its information to the gateway, and the reported information includes the location information of the home Node B, public mobile network ID, global cell ID, frequencies, scrambling, route cell ID and so on. If the home Node B covers more than one cells, the information also includes local cell ID.

2) The gateway sends to the home Node B a message including home Node B ID and gateway ID. If the home Node B covers more than one cell, the information also includes local cell ID. Meanwhile, an ID is allocated to each cell under the home Node B to uniquely identify a cell under the gateway.

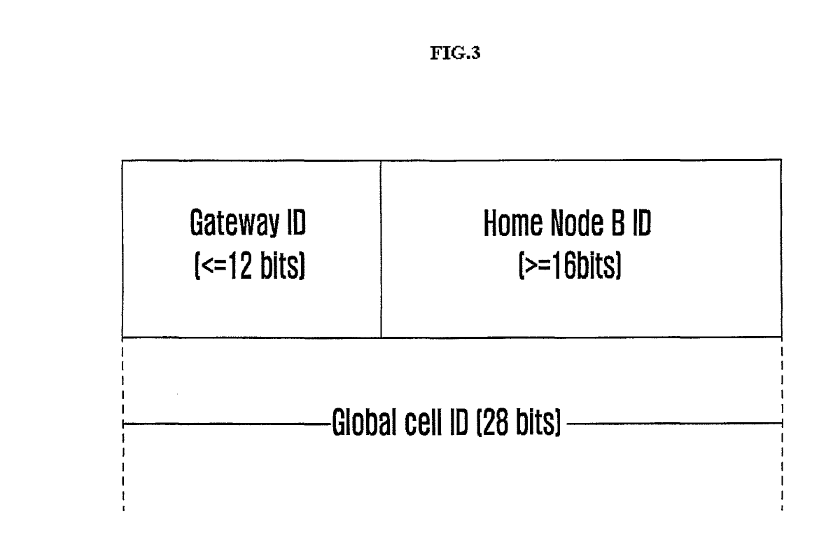

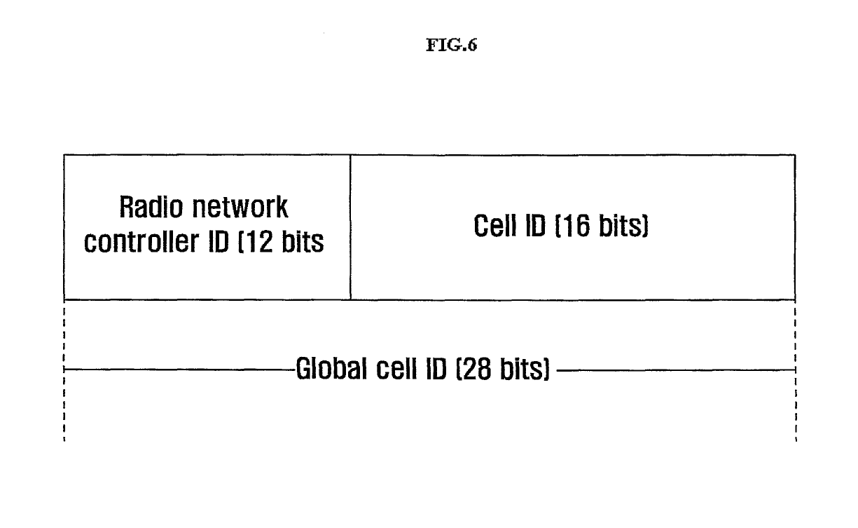

The operation and maintenance entity or the gateway configures home Node ID and gateway ID for each home Node B. The two IDs are combined to form a global cell ID. If the home Node B covers more than one cell, the gateway or the operation and maintenance entity allocates an ID to each cell of the home Node B, and this ID uniquely identifies a corresponding cell under the gateway. The gateway ID and the ID allocated to each cell is combined to form a global cell ID for the cell. Details of the combination configuration are shown in FIG. 3, where the configuration is different from the conventional one in FIG. 6. If the number of home Node Bs under one gateway can be limited below 65536, the gateway ID consists of 12 bits, and the home Node B ID consists of 16 bits.

The home Node B ID is used to uniquely identify each home Node B under one gateway, or to uniquely identify each cell under one home Node B. A gateway ID corresponds to a radio network controller ID for the gateway. Since a gateway may covers over 100,000 home Node Bs, and the conventional radio network controller controls less than 65536 cells, the home Node B can obtain the corresponding radio network controller ID according to a gateway ID. If the gateway ID is shorter than 12 bits, some zeros can be padded in as LSBs (least significant bits) to obtain the radio network controller ID. With such correspondence, the gateway can learn about whether the home Node B is under the control of the gateway itself.

Now, specific embodiments of the present patent are described.

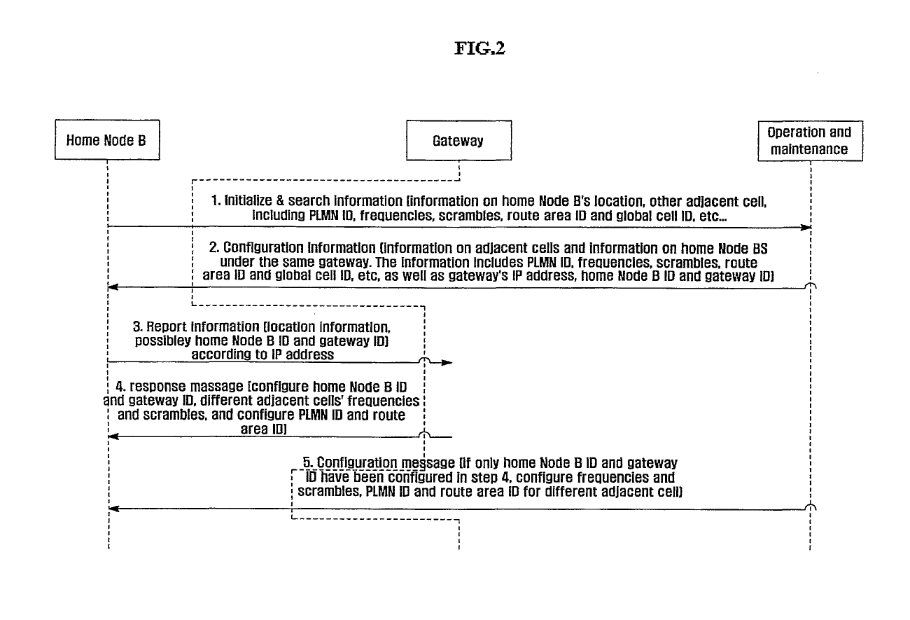

FIG. 2 shows an initialization flow for a home Node B. Although the present invention is described with reference to the embodiments, all these embodiments are intended to illustrate, other than limit, the present invention. Those skilled in the art can readily make modification, additional or deletion to these embodiments without departing from the spirit and scope of the present invention.

1) The home Node B, at the moment of initial power-on, sends to the operation and maintenance entity a message including the location information of the home Node B's location and information on adjacent cells searched by the home Node B. The information on adjacent cells includes Public Land Mobile Network ID, frequencies, scrambling, route cell ID, global cell ID, etc..

2) The operation and maintenance entity sends a message to the home Node B to configure the home Node B. The message can include information on adjacent macro cells, and information on other home Node Bs of the same group. The above cell information includes Public Land Mobile Network (PLMN) ID, frequencies, scrambling, route cell ID, global cell ID, etc., used by the cells. Further, the gateway's IP address is also included in the message. Both the home Node B ID and the gateway ID can be configured in this step.

3) The home Node B locates the corresponding gateway according to the gateway's IP address and sends to the gateway a message including the location information of the home Node B, etc. If the home Node B ID and the gateway ID have been obtained in Step 2), the message also includes the obtained home Node B ID and the gateway ID.

4) The gateway sends a response message to the home Node B. If none of the home Node B ID and the gateway ID is obtained in Step 2), the gateway will configure these IDs.

5) The gateway or the operation and maintenance entity allocates to the home Node B scrambling and frequencies different from those for adjacent cells. PLMN ID and route cell ID, etc., can also be configured.

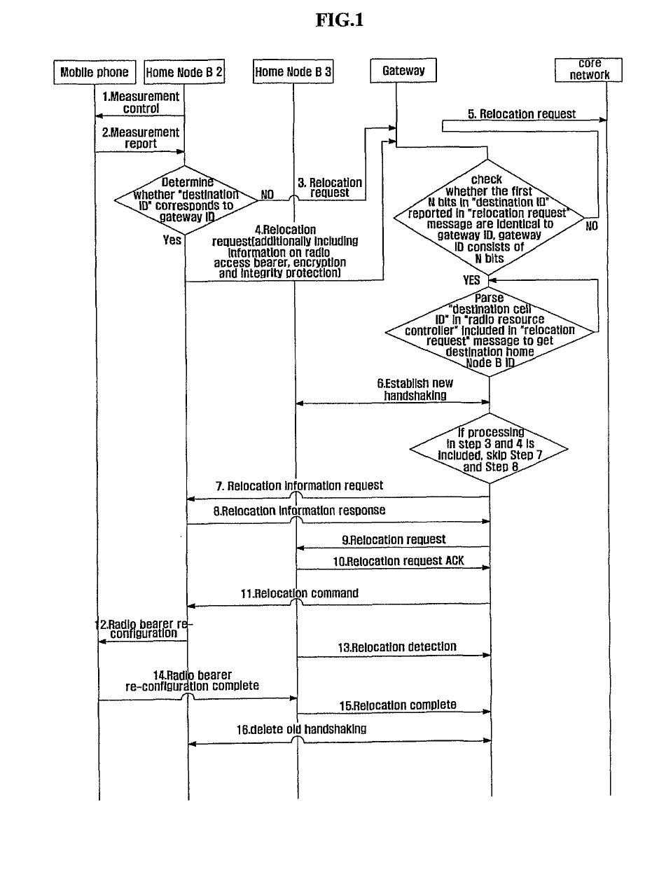

FIG. 1 shows details of a relocation signaling flow, which is described below.

1) When some UE, such as a mobile phone, enters a state of dedicated connection, the home Node B 2 starts a mobile-phone-side measurement on adjacent home Node Bs of the same group and macro cells, according to the configured information on adjacent cells.

2) Once the mobile phone measures that one of the adjacent cells satisfies report criteria, the mobile phone reports information on this measurement result to the home Node B 2. The home Node B 2 evaluates that the measurement result satisfies handover criteria, and thus initiates a relocation process. The configuration rules for main information elements in a “relocation request” message are such that the “source ID” is set as radio network ID corresponding to the gateway, the “destination ID” is set as the highest 12 bits of the global cell ID corresponding to the above adjacent cell, and the “radio routing ID” is configured according to the information on the adjacent cell. In addition, for the “transparent transmission inclusion” information element, the “destination cell ID” is the global cell ID of the adjacent cell. The home Node B 2 configures other information elements in the “transparent transmission inclusion” according to the current configurations.

3) Determination is made as to whether the “destination ID” of the adjacent cell corresponds to the gateway. The determination rule is: if the gateway ID consists of N bits, determination is made as to whether the highest N bits in the “destination ID” are identical to those in the gateway ID; if not, the process of sending the message to the gateway is performed.

4) If the “destination ID” corresponds to the gateway in the above Step 3), such information elements as the currently used “radio access bearer information”, “encryption information” and “integrity protection” can be added into the “relocation request message”. These information elements are provided external to RANAP coding message. The process of sending the message to the gateway is performed.

5) After receiving the “relocation request” message, the gateway checks whether the “destination ID” in the message corresponds to the gateway. And the correspondence rule has been introduced in Step 3). If there is no correspondence, the RANAP message is forwarded to the core network.

6) If the “destination ID” in the “relocation request” message corresponds to the gateway in Step 5), the “destination cell ID” in the “transparent transmission inclusion” information element is parsed to obtain the ID of the destination home Node B under the gateway. Then, a handshaking is established between the gateway and the target home Node B. If the RANAP message carries external information elements including “radio access bearer information”, “encryption information” and “integrity protection”, these information elements will be stored.

7) In Step 3) and Step 4), if no external information element like “radio access bearer information”, “encryption information” or “integrity protection” is added to the “relocation request” message, the gateway needs to request these information elements from the source home Node B.

8) According to the current configurations, the source home Node B responds the “radio access bearer information”, “encryption information” and “integrity protection” to the gateway. The gateway receives and stores these information elements.

9) The gateway configures the “relocation request” message and the “transparent transmission inclusion” (originating from “relocation request”). It also configures “radio access bearer information”, “encryption information” and “integrity protection”, etc., according to the stored information. Then, it sends the message to the destination home Node B.

10) The destination home Node B acts as a radio network controller. It allocates radio bearer resource, radio access control resource and physical channel resource according to the received “relocation request” message. Then, according to the allocated resources, the destination home Node B configures information elements “transparent transmission inclusion” and “radio access bearer”, etc., in a “relocation request ACK” message, and sends the message to the gateway.

11) After receiving the “relocation request ACK” message, the gateway configures the “transparent transmission inclusion” and “radio access bearer” in a “relocation command” message according to the information elements “transparent transmission inclusion” and “radio access bearer” included in the received message. Then it sends the “relocation command” message to the source home Node B upon the completion of the message configuration.

12) The source home Node B allocates radio bearer and channel resources, etc., after it receives the “relocation command” message. Then it configures a “radio bearer re-configuration” message according to the allocated resources and sends the message to the mobile phone.

13) The destination home Node B detects that the mobile phone transmits a synchronization signal. It configures and sends a “relocation detection” message to the gateway, with the message including only an information element “message type”.

14) The destination home Node B receives a “radio bearer re-configuration complete” message from the mobile phone, and the message indicates that the handover process has been completed successfully.

15) After detecting a message that the handover process has been completed, the destination home Node B sends to the gateway a “relocation complete” message including only an information element “message type”.

16) The gateway triggers to delete the handshaking between itself and the source home Node B. Now the entire handover relocation process completes.

1. A method for User Equipment (UE) handover between home Node Bs, comprising steps of:
sending, by a source home Node B that stores an ID of a connected gateway, a message to a gateway, the message including the gateway ID and a destination home Node B ID;
sending by the gateway a message to a destination home Node B identified by the destination home Node B ID to establish a radio bear of the destination home Node B for the UE;
sending by the destination home Node B a radio bearer allocated to the UE to the gateway;
sending by the gateway the radio bearer to the source home Node B;
sending by the source home Node B the radio bearer to the UE; and
completing by the UE a handover to the destination home Node B.

2. The method of claim 1, further comprising step of obtaining, by the source home Node B, the ID of the connected gateway from an operation maintenance and management entity (OAM) or the gateway.

3. The method of claim 1, wherein the message sent from the source home Node B to the gateway includes parameters required for establishment of the radio bearer.

4. The method of claim 1, wherein, before sending the message to the destination home Node B, the gateway requests the source home Node B for parameters required for establishment of the radio access, and the source home Node B returns the required parameters in a response message.

5. The method of claim 3, wherein the parameters include a radio bearer parameter, integrity protection information and encryption information.

6. The method of claim 1, wherein the message sent from the source home Node B to the gateway is a “relocation request” message.
